(19) United States
(12) Patent Application Publication
(10) Pub. No.: US 2026/0054930 A1
(43) Pub. Date: Feb. 26, 2026

(54) GOODS PICKING METHOD AND WAREHOUSING SYSTEM

(71) Applicant: BEIJING GEEKPLUS TECHNOLOGY CO., LTD., Beijing (CN)

(72) Inventors: Hongbo LI, Beijing (CN); Mengdi WANG, Beijing (CN); Fuling LV, Beijing (CN)

(21) Appl. No.: 18/995,510

(22) PCT Filed: Oct. 7, 2023
(86) PCT No.: PCT/CN2023/123233

§ 371 Date: Jan. 16, 2025

(30) Foreign Application Priority Data
Oct. 12, 2022 (CN) 202211248559.7

(51) Int. Cl. B65G 1/137

(52) U.S. Cl. CPC B65G 1/1378

(57) ABSTRACT

A method for picking goods includes controlling a workstation to place the goods to be allocated corresponding to a plurality of orders to be processed on a buffer vehicle according to a category of goods to be allocated, controlling the buffer vehicle to move and pass through a plurality of target allocation points of an allocation station, and controlling, according to a category and quantity of target goods corresponding to an associated order, among the plurality of orders to be processed, associated with an order container at each target allocation point, an allocation object to allocate the target goods on the buffer vehicle into the order container, when the buffer vehicle passes through each target allocation point.

### CROSS-REFERENCE TO RELATED APPLICATIONS

This application is a national stage entry under 35 U.S. C. § 371 of International Application PCT/CN2023/123233, filed on Oct. 7, 2023, which claims priority to Chinese Patent Application No. 202211248559.7, filed on Oct. 12, 2022, the entire disclosures of which are hereby incorporated herein by reference.

### FIELD

The present disclosure relates to the technical field of intelligent warehousing, and more particularly to a method for picking goods and a warehousing system.

### BACKGROUND

An intelligent warehousing system assists or replaces relevant management and operation of manual work by an information management system and an intelligent operation device. With an increasing degree of automation in the intelligent warehousing system in terms of storage and picking of goods, the intelligent warehousing systems has been widely used and favored due to its longer working time and higher working efficiency compared with manual work.

### SUMMARY

Embodiments of the present disclosure provide a method for picking goods and a warehousing system.

A first aspect of embodiments of the present disclosure provides a method for picking goods. The method includes controlling a workstation to place the goods to be allocated corresponding to a plurality of orders to be processed on a buffer vehicle according to a category of goods to be allocated, controlling the buffer vehicle to move and pass through a plurality of target allocation points of an allocation station, and controlling, according to a category and quantity of target goods corresponding to an associated order, among the plurality of orders to be processed, associated with an order container at each target allocation point, an allocation object to allocate the target goods on the buffer vehicle into the order container, when the buffer vehicle passes through each target allocation point.

A second aspect of embodiments of the present disclosure provides a warehousing management system. The warehousing system includes an allocation station, a workstation, a buffer device, and a control device. The allocation station is arranged with a plurality of allocation points, and each allocation point is configured to place an order container. The control device is configured to generate an unloading task according to goods to be allocated corresponding to a plurality of orders to be processed, and generate an allocation task according to a category and quantity of target goods corresponding to an associated order, among the plurality of orders to be processed, associated with an order container at each target allocation point in the allocation station. The allocation task is configured to allocate the target goods on a buffer vehicle into the order container. The workstation is coupled to the control device and configured to unload, according to the unloading task, goods to be allocated to the buffer device according to a category of the goods to be allocated. The buffer device includes the buffer vehicle. The buffer vehicle runs between the workstation and the allocation station, and the buffer vehicle is coupled to the control device and is configured to transport the goods to be allocated to the allocation station and pass through a plurality of target allocation points of the allocation station, to allow an allocation object to perform the allocation task.

A third aspect of embodiments of the present disclosure provides a control device. The control device includes a memory, and at least one processor. The memory is stored with computer-executable instructions that, when executed by the at least one processor, cause the at least one processor to perform the method for picking goods described in the first aspect.

A fourth aspect of embodiments of the present disclosure provides a non-transitory computer-readable storage medium having stored therein computer-executable instructions that, when executed by a processor, cause the processor to implement the method for picking goods described in the first aspect is realized.

A fifth aspect of embodiments of the present disclosure provides a computer program product including a computer program that, when executed by a processor, causes the processor to implement the method for picking goods described in the first aspect.

### BRIEF DESCRIPTION OF THE DRAWINGS

Other features, objects and advantages of the present disclosure will become more apparent upon reading the detailed description of non-limiting embodiments made with reference to the following drawings.

FIG. 1 is a schematic diagram illustrating a picking scenario of a picking workstation provided in some embodiments of the present disclosure.

FIG. 2 is a schematic diagram illustrating a warehousing system provided in some embodiments of the present disclosure.

FIG. 3 is a schematic diagram illustrating an allocation wall provided in some embodiments of the present disclosure.

FIG. 4 is a schematic diagram illustrating a method for picking goods provided in some embodiments of the present disclosure.

FIG. 5 is a schematic diagram illustrating another method for picking goods provided in some embodiments of the present disclosure.

FIG. 6 is a schematic diagram illustrating yet another method for picking goods provided in some embodiments of the present disclosure.

FIG. 7 is a schematic diagram illustrating yet another method for picking goods provided in some embodiments of the present disclosure.

FIG. 8 is a schematic diagram illustrating yet another method for picking goods provided in some embodiments of the present disclosure.

FIG. 9 is a schematic diagram illustrating yet another method for picking goods provided in some embodiments of the present disclosure.

FIG. 10 is a schematic diagram illustrating a method for processing a goods picking order provided in some embodiments of the present disclosure.

FIG. 11 is a schematic diagram illustrating another method for processing a goods picking order provided in some embodiments of the present disclosure.

FIG. 12 is a schematic diagram illustrating yet another method for processing a goods picking order provided in some embodiments of the present disclosure.

FIG. 13 is a schematic diagram illustrating yet another method for processing a goods picking order provided in some embodiments of the present disclosure.

FIG. 14 is a schematic diagram illustrating yet another method for processing a goods picking order provided in some embodiments of the present disclosure.

### DETAILED DESCRIPTION

The present disclosure is further described in detail below in conjunction with the accompanying drawings and embodiments. It is to be understood that specific embodiments described herein are only used to explain the relevant invention, rather than to limit the present disclosure. For ease of description, only parts related to the present disclosure are shown in the accompanying drawings.

It is to be noted that an embodiment in the present disclosure and a features in the embodiment may be combined with each other without conflict. The present disclosure is described in detail below with reference to the accompanying drawings and in combination with the embodiments.

FIG. 1 is a schematic diagram illustrating a picking scenario of a picking workstation provided in some embodiments of the present disclosure. A goods-to-person picking mode in a related technology is described below in conjunction with FIG. 1.

As shown in FIG. 1, a warehousing system may determine that a shelf h has been hit according to an order to be processed, and control handling equipment (such as a handling robot) to transport the shelf h hit by the order to be processed to a workstation s. A picking worker w of the workstation s may pick out goods (or a commodity) hit by the order to be processed from the shelf h according to prompt of a display device d, and then place hit goods into an order container r. A quantity of the goods may be one or more. That is, the goods may include one item or a plurality of items.

Using the picking mode shown in FIG. 1, the picking worker w may only pick out one category of goods from the shelf h at a time (i.e., picking a single category of items), and allocate the goods of this category to each order container r, or some order containers r. Due to this picking mode, only one category of goods may be picked out at a time, and when a numeric count of categories required for the order to be processed is large, a picking efficiency of this picking mode is low. In addition, in the above-mentioned picking process, when there are a plurality of shelves h, the plurality of shelves h need to wait in line at the workstation s for picking, which further reduces the picking efficiency.

In order to solve the above-mentioned technical problems, an embodiment of the present disclosure provides a warehousing system. A buffer vehicle is provided in the warehousing system, a plurality of categories of goods required for an order are unloaded from a carrier to the buffer vehicle, and the plurality of categories of goods on the buffer vehicle are allocated by an allocation object, such as an allocation person/a picking person/an allocation device, to allow the warehousing system support “picking a plurality of categories of items” and/or “allocating a plurality of orders”, which is beneficial to greatly improve the picking efficiency.

The warehousing system provided in the embodiment of the present disclosure is described below in conjunction with the accompanying drawings.

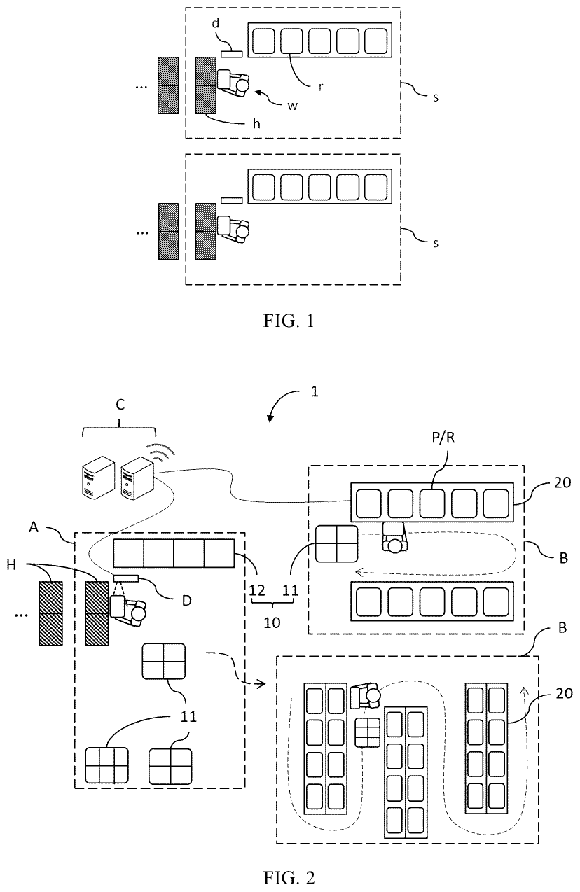

FIG. 2 is a schematic diagram illustrating a warehousing system provided in some embodiments of the present disclosure. As shown in FIG. 2, a warehousing system 1 includes a workstation A, an allocation station B, a buffer device 10 and a control device (not shown in FIG. 2).

Illustratively, the buffer device 10 may include a buffer vehicle 11. The buffer vehicle 11 is movable between the workstation A and the allocation station B. The buffer vehicle 11 may be any device suitable for carrying goods and capable of running. For example, the buffer vehicle 11 may be a cart propelled by manpower, or an automatic handling device combined with a goods container, or a trolley running along a fixed track, etc., which is not limited in the embodiment of the present disclosure.

Illustratively, the buffer device 10 may further include a buffer rack 12 provided at the workstation A. The buffer rack 12 may be configured to store goods.

In some embodiments, the control device is configured to generate an unloading task according to goods to be allocated corresponding to a plurality of orders to be processed, and generate an allocation task according to a category and quantity of target goods corresponding to an associated order, among the plurality of orders to be processed, associated with an order container at each target allocation point in the allocation station. The allocation task is configured to allocate the target goods on the buffer vehicle into the order container.

In some embodiments, the workstation is coupled to the control device and is configured to unload, according to the unloading task, the goods to be allocated to the buffer vehicle according to a category of the goods to be allocated.

As shown in FIG. 2, the workstation A may unload the goods to be allocated from a carrier H to the buffer vehicle 11. Alternatively, the workstation A may unload the goods to be allocated to the buffer rack 12 at the workstation A first, and then transport the goods to be allocated on the buffer rack 12 to the buffer vehicle 11. It is to be noted that a way of unloading the goods to be allocated to the buffer vehicle 11 via the buffer rack 12 is more suitable for a scenario with a relatively busy handling task.

In some examples, the carrier H is a carrier that carries the goods to be allocated, and the carrier may include any device for carrying the goods, including but not limited to a container and a shelf.

In some embodiments, the allocation station is arranged with a plurality of allocation points, and each allocation point is configured to place an order container. The buffer vehicle is configured to transport the goods to be allocated to the allocation station and pass through a plurality of target allocation points of the allocation station, to allow an allocation object to perform the allocation task.

As shown in FIG. 2, the allocation station B is arranged with a plurality of allocation points P, and each allocation point P may be configured to place an order container R. The buffer vehicle 11 is configured to transport goods (i.e. goods to be allocated) that is carried on the buffer vehicle 11 to the allocation station B, to allow an allocation object to allocate goods to a target allocation point among the plurality of allocation points P at the allocation station B.

Illustratively, the allocation object includes an allocation device and an allocation person. The allocation object is configured to allocate the goods to be allocated on the buffer vehicle 11 into an order container R at a corresponding target allocation point according to the allocation task. For example, when the allocation object is the allocation device, the allocation device may allocate the goods to be allocated on the buffer vehicle 11 into the order container R at the corresponding target allocation point according to the allocation task sent by the control device. When the allocation object is the allocation person, the control device may generate allocation prompt information according to the allocation task, and the allocation prompt information is outputted by the information input/output device in the warehousing system. The allocation person allocates the goods to be allocated on the buffer vehicle 11 into the order container R at the corresponding target allocation point according to the allocation prompt information.

In some embodiments, the allocation station B includes an allocation wall 20, and the order container R is placed at each allocation point P on the allocation wall 20.

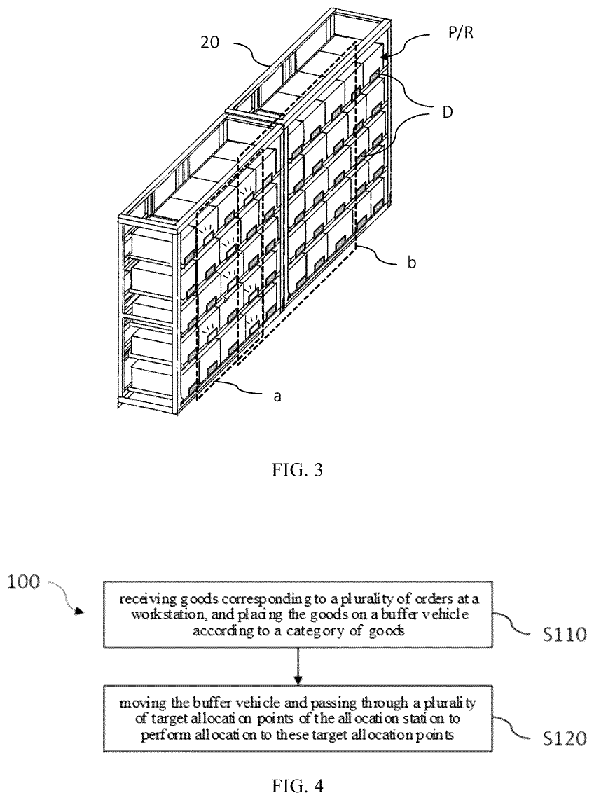

FIG. 3 is a schematic diagram illustrating an allocation wall provided in some embodiments of the present disclosure. As shown in FIG. 3, the allocation wall 20 includes a plurality of allocation points P.

In some embodiments, allocation walls 20 exist and may be arranged in parallel, such as two or more rows, or allocation walls 20 may also be arranged in a U-shape.

In some examples, when goods are allocated to the plurality of target allocation points, allocating of goods may be performed along a shortest path passing through the allocation wall 20. For example, a U-shaped route shown by a dotted line in FIG. 2 may be used for allocation.

Illustratively, the warehousing system 1 may include one or more workstations A, and each workstation A may receive goods of one or more allocation stations B. For example, different workstations A may receive goods of a same allocation station B. That is, the workstation A and the allocation station B served by the workstation A may not be limited to a certain correspondence.

The warehousing system 1 provided in the embodiment of the present disclosure may separate an operation of unloading the goods to be allocated on the carrier H to the buffer vehicle 11 (also referred to as an operation of picking items) from an operation of performing allocating to the order container R (also referred to as an operation of allocation).

In some examples, since the buffer vehicle 11 may carry more categories and/or larger quantities of goods than manual labor, the warehousing system 1 may support an operation of picking the plurality of categories of items (that is, more than one category of goods may be taken from the carrier H and placed on the buffer vehicle 11) and an operation of allocating the plurality of orders (that is, goods may be allocated to order containers R at the plurality of target allocation points).

For example, the warehousing system 1 may unload a plurality of categories of goods to one buffer vehicle 11 at the workstation A, and use the buffer vehicle 11 to allocate the goods to order containers at the plurality of target allocation points in the allocation station. That is, the warehousing system 1 may simultaneously implement the operation of picking the plurality of categories of items and the operation of allocating the plurality of orders, which is conducive to greatly improving the picking efficiency.

It is to be noted that the warehousing system 1 may also use the buffer vehicle 11 to perform picking in a manner of “picking the single category of items” plus “allocating the plurality of orders”. Since the allocation of goods to the plurality of order containers R may be completed in a process that the buffer vehicle 11 passes through the plurality of target allocation points while moving at one time, the picking efficiency may also be effectively improved.

In some examples, the buffer device 10, such as the buffer vehicle 11, receives and buffers goods on the carrier H arriving at the workstation A, which may greatly shorten residence and waiting time of the carrier H at the workstation A, so as to release the carrier H for goods transportation or for new picking tasks at other workstations, thus contributing to further improving the picking efficiency.

Meanwhile, in the warehousing system 1 of the embodiment of the present disclosure, since the operation of taking goods off the carrier H is separated from the operation of allocating goods to the order container by using the buffer vehicle 11, a cooperation relationship between the workstation A and the allocation station B may be dynamic. That is, buffer vehicles 11 from one workstation A may be dynamically assigned to different allocation stations B, and one allocation station B may also dynamically receive buffer vehicles 11 from different workstations A for allocation. Such a dynamic cooperation relationship facilitates assignment of tasks and scheduling of goods carriers H among various workstations, improving an overall efficiency and throughput of workstations, shortening the residence time of carrier H at the workstation A, and improving an utilization rate of carriers, thus improving the picking efficiency in a goods storage area.

As shown in FIG. 2, the warehousing system 1 may further include a warehouse management system C and an information input/output device D coupled to the warehouse management system C. The warehouse management system C may be the control device in the above-mentioned embodiment. For example, the warehouse management system C may be a server device or the like, which is not limited in the embodiment of the present disclosure.

In some examples, the warehouse management system C may be a computer-based system, including a memory and at least one processor. The memory is stored with computer-executable instructions that, when executed by the at least one processor, cause the at least one processor to perform operations of the method for picking goods provided in the embodiments of the present disclosure. For example, the warehouse management system C may be coupled to the workstation A, the allocation station B, and the buffer vehicle 11, respectively, and is configured to control operations of the workstation A, the allocation station B, and the buffer vehicle 11.

Illustratively, the information input/output device D may be connected to the warehouse management system C in a wired or wireless manner. For example, the information input/output device D may collect goods information, task completion information, and task information and prompt information output by the warehouse management system C. The information input/output device D is an integrated device that integrates input and output functions, and may also include independent devices that are used for information input and information output, respectively.

Illustratively, the information input/output device D may include at least one of a display device, a voice device and a lighting device, such as a touch screen, an electronic tag, a handheld display device, a wearable display device, a voice playback device, a voice recognition device, an indicator light or the like. For example, as shown in FIG. 3, an electronic tag with a touch screen function may be provided on corresponding allocation points P on the allocation wall 20.

The method for picking goods provided in the embodiment of the present disclosure is described in detail below with reference to FIGS. 4 to 9.

FIG. 4 is a schematic diagram illustrating a method for picking goods provided in some embodiments of the present disclosure. For example, a method for picking goods 100 in FIG. 4 may be implemented by the warehousing system 1, for example, may be implemented by the control device in the warehousing system 1 as shown in FIG. 2.

As shown in FIG. 4, the method for picking goods 100 includes S110 to S120 as shown below.

In S110, goods corresponding to a plurality of orders are received at a workstation, and the goods are placed on a buffer vehicle according to a category of goods.

In some embodiments, the control device generates an unloading task according to goods to be allocated corresponding to a plurality of orders to be processed, and sends the unloading task to the workstation. The workstation receives the unloading task, and places, according to the unloading task, the goods to be allocated on the buffer vehicle according to a category of the goods to be allocated.

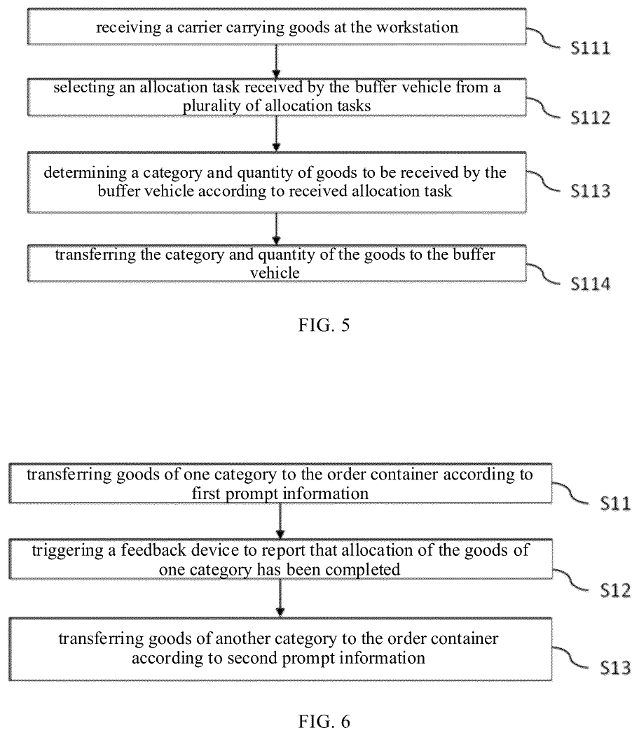

FIG. 5 is a schematic diagram illustrating another method for picking goods provided in some embodiments of the present disclosure. As shown in FIG. 5, the above-mentioned S110 may include S111 to S114 as shown below.

In S111, a carrier carrying goods is received at the workstation.

In some embodiments, the control device controls a mobile device to transport a carrier on which the goods to be allocated corresponding to the plurality of orders to be processed are located to the workstation.

For example, when the mobile device transports the carrier carrying the goods to be allocated to the workstation, the workstation receives the carrier and performs a further unloading operation on the carrier.

In S112, an allocation task received by the buffer vehicle is selected from a plurality of allocation tasks generated according to the goods and the plurality of orders to allocate goods to a plurality of target allocation points.

In S113, a category and quantity of goods to be received by the buffer vehicle is determined according to the allocation task received by the buffer vehicle.

In S114, the category and quantity of the goods are transferred to the buffer vehicle.

In some embodiments, the control device determines a category and quantity of the goods to be allocated according to the plurality of orders to be processed. The workstation is controlled to place the goods to be allocated on the buffer vehicle according to the category and quantity of the goods to be allocated.

In the process S111, as shown in FIG. 2, the workstation A of the warehousing system 1 receives the carrier H carrying goods (such as the goods to be allocated) corresponding to the plurality of orders (such as the plurality of orders to be processed) resulting from the completion of picking goods from the goods storage area. The carrier H may be transported to the workstation A by the mobile device. For example, the mobile device may be a handling robot.

Through the above-mentioned S112 to S114, unloading the goods to be allocated corresponding to the plurality of orders to be processed on the carrier H to the buffer vehicle 11 may be implemented.

Illustratively, the workstation A may perform unloading operations continuously until all goods corresponding to the plurality of orders on the carrier H are unloaded to the buffer device 10. This may shorten a residence time of the carrier H at the workstation A and improve a utilization efficiency of the carrier H.

Illustratively, the buffer device 10 may include a plurality of buffer vehicles 11 and/or at least one buffer rack 12. In this way, even in a case of a large number of picking orders, it is possible to maintain a smooth connection between picking work carried out in the storage area and picking work carried out at the workstation A and the allocation station B.

In some embodiments, in S110, at least two categories of goods may be unloaded onto a same buffer vehicle 11. That is, at least two categories of goods may be placed on one buffer vehicle 11.

In some embodiments, the buffer vehicle 11 may be provided with a plurality of compartments, and a plurality of goods may be placed in each compartment. For example, a same category of goods may be placed in a same compartment. In S110, different categories of goods may be unloaded into different compartments of the buffer vehicle 11, which is conducive to improving the allocation efficiency at the allocation station and reducing an error rate of allocation.

Illustratively, the goods may be unloaded onto the buffer vehicle 11 according to a predetermined correspondence between a position of each compartment on the buffer vehicle 11 and a category of goods. Therefore, at a time of allocation, corresponding goods may be taken out sequentially according to the positions of the plurality of compartments of the buffer vehicle 11 and allocated, which may reduce an attention requirement for an operator, thus reducing an error rate in a process of picking up and delivering goods, and improving an picking efficiency.

In some embodiments, controlling the mobile device to transport the carrier on which the goods to be allocated are located to the workstation includes controlling the mobile device to transport the carrier on which the goods to be allocated are located to the workstation according to an unloading situation of goods at the workstation.

Illustratively, the warehousing system 1 may include a plurality of workstations. In a case that the warehousing system 1 includes a plurality of workstations A, before executing S110, the method for picking goods 100 may further include taking out goods from a storage area by using a plurality of carriers H, transporting the goods to a work area where the plurality of workstations A are located, and scheduling a sequence in which the plurality of carriers H arrive at different workstations A in the work area according to an unloading situation of goods at each workstation A.

In some embodiments, the unloading situation of the goods may include at least one of: (1) an expected return time of a buffer vehicle; (2) a numeric count of carriers waiting in line to unload goods; or (3) a category and quantity of goods waiting in line to be unloaded.

In some examples, the expected return time of the buffer vehicle 11 may be determined according to a start time or an expected completion time at which the buffer vehicle 11 performing an operation of transporting the goods to be allocated to the target allocation point for allocation. For example, an expected return time of the buffer vehicle 11 that starts allocating at the allocation station earlier may be earlier.

In some examples, the number of carriers waiting in line at the workstation A as well as the category and quantity of goods waiting to be unloaded may both affect a queuing time of a carrier that is newly or about to arrive at the workstation A. For example, the more carriers waiting in line at the workstation A, and/or the more categories and quantities of goods waiting to be unloaded, the longer the queuing time of the carrier arriving at the workstation A will be.

Illustratively, in the warehousing system 1, the cooperation relationship between the workstation A and the allocation station B may be dynamic. Based on this dynamic cooperation relationship, the carrier H is scheduled and picking tasks are assigned accordingly among various workstations, which may improve an overall efficiency and throughput of the plurality of workstations and shorten the residence time of carrier H in the workstation A.

In S120, the buffer vehicle moves and passes through a plurality of target allocation points of the allocation station to perform allocation to these target allocation points. When passing through a target allocation point, a corresponding category and quantity of goods in the buffer vehicle is transferred to the order container according to an associated order, among the plurality of orders, associated with an order container located at one target allocation point.

In some embodiments, the control device controls the buffer vehicle to move and pass through the plurality of target allocation points of the allocation station.

In some examples, the control device may send a movement task to the buffer vehicle, and the buffer vehicle moves according to the movement task and passes through the plurality of target allocation points of the allocation station. The target allocation point is an allocation point to be allocated among the plurality of allocation points.

In some embodiments, when the buffer vehicle passes through each target allocation point, the control device controls an allocation object to allocate the target goods on the buffer vehicle into the order container according to a category and quantity of target goods corresponding to an associated order, among the plurality of orders to be processed, associated with an order container at each target allocation point.

Illustratively, the control device may generate an allocation task according to the goods to be allocated corresponding to the plurality of order to be processed. When the allocation object is an allocation device, the allocation device may allocate the target goods on the buffer vehicle 11 into the order container R according to the allocation task. When the allocation object is an allocation person, the control device may generate allocation prompt information, the allocation prompt information is outputted by the input/output device D, and the allocation person may allocate the target goods on the buffer vehicle 11 into the order container R according to the allocation prompt information.

In some embodiments, in S120, allocating goods to the plurality of target allocation points may include at least one of: (1) transferring at least two categories of goods on the buffer vehicle into an order container located at one target allocation point; or (2) transferring different categories of goods on the buffer vehicle to order containers located at different target allocation points, respectively.

It is to be noted that both of the above-mentioned situations may implement allocation of a non-single category of items, which is conducive to greatly improving the picking efficiency.

A process of performing allocation at the allocation station in S120 is described below with reference to FIGS. 6 to 9. It is to be noted that the different methods described below are not mutually exclusive, and they may be executed at different times or for different allocation points in a same warehousing system, or may also be combined and executed at a same time and for a same allocation point.

FIG. 6 is a schematic diagram illustrating yet another method for picking goods provided in some embodiments of the present disclosure. As shown in FIG. 6, the above-mentioned S120 includes S11 to S13 as shown below.

In S11, goods of one category are transferred from the buffer vehicle to the order container according to first prompt information.

In S12, a feedback device is triggered to report that allocation of the goods of one category has been completed.

In S13, goods of another category are transferred from the buffer vehicle to the order container according to second prompt information.

In some examples, the first prompt information and the second prompt information in S11 to S13 may be provided to, for example, an operator (such as an allocation person) by the information input/output device D. The information input/output device D may be a display device or a voice device.

In some examples, the feedback device may be a part of the information input/output device D of the warehousing system 1, which has an information input function. For example, the feedback device may be triggered to input feedback information by pressing, touching a screen, scanning or making a sound, etc. The warehouse management system C of the warehousing system 1 may give the second prompt information after the feedback information is received by the feedback device.

That is, in some embodiments, if the allocation object is an allocation device, controlling the allocation object to allocate at least two categories of the target goods on the buffer vehicle into an order container at one target allocation point includes generating a first allocation task and a second allocation task according to the category and quantity of the target goods corresponding to the order container at the target allocation point; in which the first allocation task is configured to instruct the allocation device to allocate target goods of a first category from the buffer vehicle to the order container at the target allocation point; and the second allocation task is configured to instruct the allocation device to allocate target goods of a second category from the buffer vehicle to the order container at the target allocation point; and controlling the allocation device to perform the first allocation task, and controlling the allocation device to perform the second allocation task in response to the allocation device completing the first allocation task.

In some examples, after completing the first allocation task, the allocation device may send feedback information that the first allocation task has been completed to the control device. In response to receiving the feedback information, the control device may send the second allocation task to the allocation device, to make the allocation device continue to perform the second allocation task.

In some embodiments, if the allocation object is an allocation person, controlling the allocation object to allocate at least two categories of the target goods on the buffer vehicle into an order container at one target allocation point includes generating first allocation prompt information according to the category and quantity of the target goods corresponding to the order container at the target allocation point, in which the first allocation prompt information is configured to prompt the allocation person to allocate target goods of a first category from the buffer vehicle to the order container at the target allocation point, and generating second allocation prompt information in response to the allocation person completing allocation of the target goods of the first category, in which the second allocation prompt information is configured to prompt the allocation person to allocate target goods of a second category from the buffer vehicle to the order container at the target allocation point.

In some examples, the control device may send the first allocation prompt information to the information input/output device D, and the input/output device D, such as a display screen, outputs first allocation display information. The allocation person may perform a first allocation task according to the first allocation prompt information. After the allocation person completes the first allocation task, and feedback information that the first allocation task has been completed may be sent to the control device by the input/output device D, for example by triggering the feedback device. The control device may send the second allocation prompt information to the information input/output device D in response to receiving the feedback information, and the allocation person may perform a second allocation task according to the second allocation prompt information.

It is to be noted that the first allocation prompt information and the second allocation prompt information may be the first prompt information and the second prompt information in the above-mentioned S11 to S13.

According to the method shown in FIG. 6, a plurality of categories of goods may be allocated according to the prompt information of the input/output device D for one allocation point until all allocation tasks for current order containers at the allocation point have been completed. The operator may allocate goods to a next allocation point after allocating the goods to the one allocation point is completed.

Illustratively, after all the allocation tasks for the current order containers have been completed (that is, order picking of the order container has been completed) for one allocation point, the method for picking goods 100 may further include replacing the order container at the allocation point. For example, the input/output device D may output prompt information to prompt replacement of the order container at the allocation point.

In some examples, a conveyor belt or a conveyor line may be arranged on one side of the allocation wall, and the conveyor belt or the conveyor line may transport an order container that has completed allocation to a station. Alternatively, the conveyor belt or the conveyor line may transport an empty order container to the allocation wall. Alternatively, an empty order container may also be stacked on one side of the allocation wall for more convenient replacement.

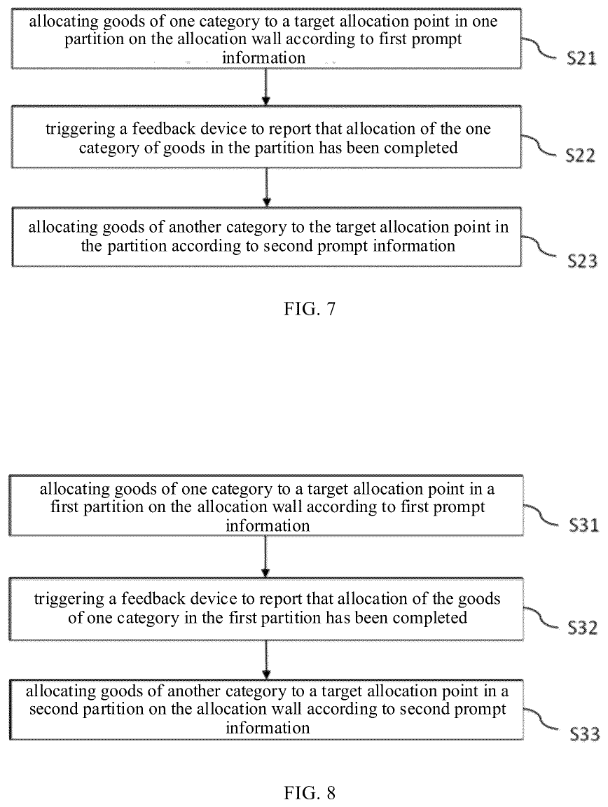

FIG. 7 is a schematic diagram illustrating yet another method for picking goods provided in some embodiments of the present disclosure. As shown in FIG. 7, the above-mentioned S120 includes S21 to S23 as shown below.

In S21, goods of one category are allocated to a target allocation point in one partition on the allocation wall according to first prompt information.

In S22, a feedback device is triggered to report that allocation of the one category of goods in the partition has been completed.

In S23, goods of another category are allocated to the target allocation point in the partition according to second prompt information.

In some embodiments, the allocation station includes an allocation wall, and a plurality of allocation points including the target allocation point are arranged on the allocation wall. The allocation wall is divided into a plurality of partitions.

In some examples, one partition on the allocation wall may include at least two allocation points.

In some embodiments, one partition may correspond to one allocation wall, or correspond to one shelf in the allocation wall, or may also correspond to a partial area of one shelf in the allocation wall, or may also correspond to an adjacent area on different shelves.

In the method for picking goods 100 according to the embodiment of the present disclosure, the partition is an area formed by two or more adjacent allocation points on the allocation wall. As shown in FIG. 3, partitions a and b are schematically shown in dashed boxes.

In some examples, the partition may be fixedly set or dynamically determined according to a category and/or quantity of goods required by the order container at the allocation point, for example.

In some embodiments, each partition may be configured with an information input/output device D, such as an electronic tag with a touch screen function, independently controlled by the warehouse management system C. Information input/output devices D of the plurality of partitions may be controlled by a plurality of controllers or by a same controller. Using a single controller to control the information input/output devices D of the plurality of partitions may further reduce cost.

According to the method shown in FIG. 7, allocation may be performed in batches in one partition according to a category of goods. In this case, on the one hand, for the operator, only goods of a same category need to be taken out from the buffer vehicle in one stage, and when the goods deliver to the order container, it does not need to distinguish a category of goods required by each target allocation point, which reduces an attention requirement of the operator and may effectively reduce an error rate in a process of picking and delivering goods, thus improving a picking efficiency. On the other hand, the partition may be set so that the operator only needs a little movement or does not need to move a position when allocating goods to the partition. Partition allocation may significantly reduce an amount of movement required for allocation compared to allocating a single category of goods in multiple batches on an entire allocation wall (only one category of goods is allocated each time in a process of passing through the entire allocation wall), and thus improve the allocation/picking efficiency.

In some embodiments, in the method shown in FIG. 7, allocation may be performed in the partition according to a predetermined sequence of categories of goods. After allocation of one category of goods in the partition is completed, an order container that has been picked is immediately replaced, and the predetermined sequence is maintained to continue to perform allocation in the partition.

That is, in some embodiments, the control device may control, according to an allocation sequence corresponding to the category of the target goods, the allocation object to allocate target goods into an order container at a target allocation point in a partition, replace an order container that has completed allocation after the order container has completed the allocation, and continue to perform allocation in a partition in line with the allocation sequence.

In some examples, if the allocation object is an allocation device, the control device may send the allocation sequence to the allocation device, to make the allocation device allocate goods to the order container at the target allocation point in the partition according to the allocation sequence. If the allocation target is an allocation person, the control device may send the allocation sequence to the input/output device D, and the input/output device D displays the allocation sequence to prompt the allocation person to allocate goods to the order container at the target allocation point in the partition according to the allocation sequence.

FIG. 8 is a schematic diagram illustrating yet another method for picking goods provided in some embodiments of the present disclosure. As shown in FIG. 8, the above-mentioned S120 includes S31 to S33 as shown below.

In S31, goods of one category are allocated to a target allocation point in a first partition on the allocation wall according to first prompt information. The first partition includes two or more allocation points.

In S32, a feedback device is triggered to report that allocation of the goods of one category in the first partition has been completed.

In S33, goods of another category are allocated to a target allocation point in a second partition on the allocation wall according to second prompt information. The second partition includes two or more allocation points, and the second partition partially overlaps with the first partition.

For example, the two partitions a and b shown in FIG. 3 may be taken as examples of the first partition and the second partition applied in this method, respectively. The first partition and the second partition may be fixedly set, or may also be dynamically determined according to a category and/or quantity of goods required by the order container at the allocation point, for example.

It is to be noted that the method shown in FIG. 8 may be used in combination with the method shown in FIG. 7, and further reflects the flexibility of the partition in the present disclosure. For example, in the first partition, partition allocation may be performed according to the method shown in FIG. 7, but it is not limited to allocation of all available goods at all target allocation points in the first partition that need to be completed at this stage. Instead, the partition may be dynamically adjusted according to a category of goods required by an adjacent target allocation point, and allocation tasks of some categories of goods may be assigned to a new partition for completion. The method shown in FIG. 8 provides further flexibility, allowing continuous optimization of an allocation program by a management system with powerful computing power.

That is, in some embodiments, if the allocation object is an allocation device, controlling the allocation object to allocate the target goods on the buffer vehicle into the order container includes generating a third allocation task and a fourth allocation task according to a category and quantity of target goods corresponding to a target allocation point in a first partition, controlling the allocation device to perform the third allocation task, and controlling the allocation device to perform the fourth allocation task in response to the allocation device completing the third allocation task. The third allocation task is configured to instruct the allocation device to allocate target goods of a third category from the buffer vehicle to an order container at the target allocation point in the first partition, the first partition is one of the plurality of partitions, the fourth allocation task is configured to instruct the allocation device to allocate target goods of a fourth category from the buffer vehicle to an order container at a target allocation point in the first partition or a second partition, and the second partition is a partition among the plurality of partitions that is different from the first partition.

In some examples, after completing the third allocation task, the allocation device may send feedback information that the third allocation task has been completed to the control device. In response to receiving the feedback information, the control device may send the fourth allocation task to the allocation device, to make the allocation device continue to perform the fourth allocation task. That is, the allocation device may allocate different categories of target goods in a same partition. Alternatively, the allocation device may also allocate different categories of target goods in different partitions.

In some embodiments, if the allocation object is an allocation person, controlling the allocation object to allocate the target goods on the buffer vehicle into the order container includes generating third allocation prompt information according to a category and quantity of target goods corresponding to a target allocation point in a first partition, in which the third allocation prompt information is configured to prompt the allocation person to allocate target goods of a third category from the buffer vehicle to an order container at the target allocation point in the first partition and the first partition is one of the plurality of partitions, and generating fourth allocation prompt information, in response to the allocation person completing allocation of the target goods of the third category, in which the fourth allocation prompt information is configured to prompt the allocation person to allocate target goods of a fourth category from the buffer vehicle to an order container at a target allocation point in the first partition or a second partition, in which the second partition is a partition among the plurality of partitions that is different from the first partition.

It is to be noted that the third allocation prompt information is similar to the first prompt information in S21 to S23 and S31 to S33, and the fourth allocation information is similar to the second prompt information in S21 to S23 and S31 to S33. When the fourth allocation prompt information is configured to prompt the allocation person to allocate the target goods of the fourth category from the buffer vehicle to the order container at the target allocation point in the first partition, this method is consistent with the method shown in FIG. 7 in the above-mentioned embodiment, and when the fourth allocation prompt information is configured to prompt the allocation person to allocate the target goods of the fourth category from the buffer vehicle to the order container at the target allocation point in the second partition, this method is consistent with the method shown in FIG. 8 in the above-mentioned embodiment, which will not be elaborated herein to avoid repetition.

In some examples, the control device may send the third allocation prompt information to the information input/output device D, and the input/output device D (such as a display screen) outputs third allocation display information. The allocation person may perform a third allocation task according to the third allocation prompt information, that is, the allocation person allocates the target goods of the third category from the buffer vehicle to the order container at the target allocation point in the first partition. After the allocation person completes the third allocation task, feedback information that the third allocation task has been completed may be sent to the control device by the input/output device D, for example by triggering the feedback device. In response to receiving the feedback information, the control device sends the fourth allocation prompt information to the information input/output device D. The allocation person may perform a fourth allocation task according to the fourth allocation prompt information, that is, the allocation person allocates the target goods of the fourth category from the buffer vehicle to the order container at the target allocation point in the first partition or a second partition.

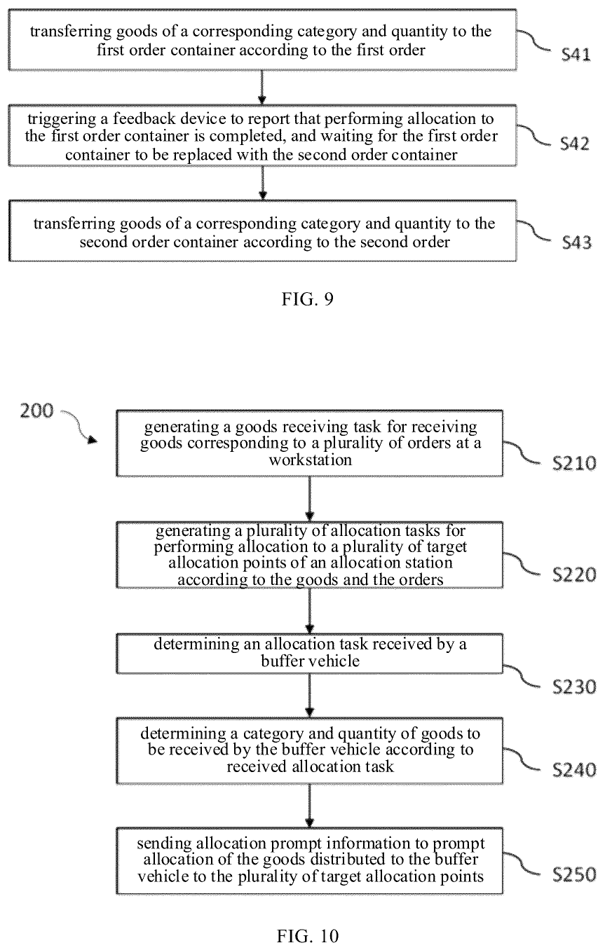

FIG. 9 is a schematic diagram illustrating yet another method for picking goods provided in some embodiments of the present disclosure. As shown in FIG. 9, the above-mentioned S120 includes S41 to S43 as shown below.

In some embodiments, for one target allocation point, the associated order may include a first order and a second order. The first order is associated with a first order container currently located at the target allocation point, and the second order is associated with a second order container to be placed at the target allocation point after the first order is completed.

In some embodiments, in the process S120, goods corresponding to the first order and the second order may be placed on one buffer vehicle.

In S41, goods of a corresponding category and quantity are transferred from a buffer vehicle to the first order container according to the first order.

In S42, a feedback device is triggered to report that performing allocation to the first order container is completed, and it waits for the first order container to be replaced with the second order container.

In S43, goods of a corresponding category and quantity are transferred from a buffer vehicle to the second order container according to the second order.

In some examples, during the implementation of the method shown in FIG. 9, the first order and the second order may satisfy at least one of following conditions: (1) at least two categories of goods in the buffer vehicle are transferred to the first order container; (2) at least two categories of goods in the buffer vehicle are transferred to the second order container; or (3) different categories of goods in the buffer vehicle are transferred to the first order container and the second order container, respectively.

The above-mentioned three situations all implement allocation of a non-single category of goods in an operation process of using the buffer vehicle to take goods off the carrier and allocate them to the order container, which is conducive to greatly improving the picking efficiency.

In some examples, in a case of allocating the non-single category of goods, in the process S41, the information input/output device D may be configured to provide a plurality of prompt information for the first order to prompt the allocation person to allocate a plurality of categories of goods to the first order container. The same situation occurs in the process S43.

That is, in some embodiments, controlling the allocation object to allocate the target goods on the buffer vehicle into the order container includes controlling the allocation object to allocate target goods of a category and quantity corresponding to the first order from the buffer vehicle to the first order container, and controlling the allocation object to transfer target goods of a category and quantity corresponding to the second order from the buffer vehicle to the second order container, in response to the first order container completing allocation and the first order container being replaced with the second order container.

In some examples, if the allocation object is an allocation device, the control device may generate a corresponding allocation task according to the first order and send a first order allocation task to the allocation device. The allocation device executes the first order allocation task. That is, the allocation device allocates the target goods of the category and quantity corresponding to the first order from the buffer vehicle to the first order container. After completing the first order allocation task, the allocation device sends completion feedback information to the control device, and the control device generates a second order allocation task according to the completion feedback information and sends the second order allocation task to the allocation device. The allocation device executes the second order allocation task. That is, the allocation device transfers the target goods of the category and quantity corresponding to the second order from the buffer vehicle to the second order container.

In some examples, if the allocation target is an allocation person, the control device may generate corresponding allocation prompt information according to the first order and send first order allocation prompt information to the information input/output device D. The information input/output device D outputs the first order allocation prompt information to prompt the allocation person to allocate the target goods of the category and quantity corresponding to the first order from the buffer vehicle to the first order container according to the first order allocation prompt information. After the allocation person completes a first order allocation task, completion feedback information may be sent to the control device by the information input/output device D, for example by triggering the feedback device. The control device generates second order allocation prompt information according to the completion feedback information and sends the second order allocation prompt information to the information input/output device D, and the information input/output device D outputs the second order allocation prompt information to prompt the allocation person to transfer the target goods of the category and quantity corresponding to the second order from the buffer vehicle to the second order container according to the second order allocation prompt information.

It is to be noted that this method is similar to the above-mentioned methods S41 to S43 in FIG. 9, which will not be elaborated herein to avoid repetition.

It is to be noted that the method shown in FIG. 9 may be configured to perform joint allocating/picking of the first order and the second order. The method of joint allocating of a plurality of orders shown in FIG. 9 makes full use of characteristics that the buffer vehicle is able to carry a plurality of categories and a large number of goods, and may achieve efficient order picking.

In some embodiments, the method for picking goods 100 may further include checking a relevant order container to which a same batch of goods is allocated by using a same buffer vehicle and/or a relevant shelf, when an error occurs in the category and quantity of the goods in the order container at the target allocation point or on the buffer vehicle. Such a check may be completed by the operator, or may be completed by a system calling data and verifying the data, or may be completed by the operator with an assistance of a system.

For example, when goods are allocated to a last allocation point, if an error occurs in a quantity of goods of a certain category, the system may provide prompt information and provide information about the relevant order container (which may be all or part of order containers to which a same batch of goods is allocated by using a same buffer vehicle) for verification. As another example, after picking work of one order is completed, if it is found that an error occurs in goods of a certain category during packaging and review of goods in an order container, the system may call order containers of all or part of other orders in a batch related to the order for verification.

Illustratively, the check in the method for picking goods may further include a processing mode of reporting out-of-stock. For example, when an operator finds that a last order container is short of one item of a certain category of goods when allocating goods to the last allocation point, the operator may report an out-of-stock situation to the system by an information input device, such as an electronic tag with a touch screen function, and the system generates a new allocation task or modifies an existing related allocation task (modifies the category or quantity of goods to be allocated corresponding to the order container) in response to receiving this report, so as to complete the above-mentioned check work.

Illustratively, the check in the method for picking goods may further include recalling a carrier related to an order container or a buffer vehicle in which an error occurred to the workstation during a checking process, and checking whether the category and quantity of the goods on the carrier are correct, and/or when it is found that an error occurs in a category or a quantity of goods unloaded from the carrier onto the buffer vehicle at the workstation during a checking process, a relevant carrier is recalled to the workstation and the category and the quantity of goods on the carrier are adjusted to eliminate the error.

The above-mentioned retrospective recall processing of carrier may help to confirm a reason for occurring an error in goods in the order container or on the buffer vehicle as soon as possible, and also help to correct the error in the goods on the carrier in time to avoid affecting picking goods at other workstations, thus improving a picking efficiency as a whole.

An embodiment of the present disclosure further provides a method for processing a goods picking order, which may be executed by the warehouse management system 1 in the warehousing system 1, and the information input/output device D may be configured to assist in executing the method for processing the picking order. The execution of the method for processing the goods picking order may be configured to assist in implementing the method for picking goods according to the embodiment of the present disclosure.

FIG. 10 is a schematic diagram illustrating a method for processing a goods picking order provided in some embodiments of the present disclosure. As shown in FIG. 10, a method for processing a goods picking order 200 includes steps as follows.

In S210, a goods receiving task for receiving goods corresponding to a plurality of orders at a workstation is generated.

In S220, a plurality of allocation tasks for performing allocation to a plurality of target allocation points of an allocation station is generated according to the goods and the plurality of orders.

In S230, an allocation task received by a buffer vehicle is determined.

In S240, a category and quantity of goods to be received by the buffer vehicle is determined according to the allocation task received by the buffer vehicle.

In S250, allocation prompt information is sent to prompt allocation of the goods distributed to the buffer vehicle to the plurality of target allocation points. For each target allocation point, a prompt is given to transfer a category and quantity of goods corresponding to an associated order in the buffer vehicle to an order container.

In the process S230, the warehouse management system C may automatically assign an allocation task to the buffer vehicle 11 to determine the allocation task received by the buffer vehicle, or the warehouse management system C may also determine an allocation task received by the buffer vehicle in response to an operator selecting the allocation task.

In some embodiments, through the above-mentioned processes S220 to S240, two or more categories of goods are allocated to a same buffer vehicle.

In some embodiments, generating the allocation task received by the same buffer vehicle includes at least one of: (1) generating an allocation task to transfer at least two categories of goods in the buffer vehicle to an order container located at one target allocation point; or (2) generating an allocation task to transfer different categories of goods in the buffer vehicle to order containers located at different target allocation points.

The above-mentioned two situations are used to implement allocation of a non-single category of goods in an operation process of using the buffer vehicle to take goods off the carrier and allocate them to the order container, which is conducive to greatly improving the picking efficiency.

Illustratively, in the case that the warehousing system 1 includes the plurality of workstations A, the method for processing the goods picking order 200 may further include generating a handling task of taking out goods from a storage area by using a plurality of carriers and transporting the goods to a work area where the plurality of workstations are located, and scheduling a sequence in which the plurality of carriers arrive at different workstations in the work area according to an unloading situation of goods at each workstation.

In some embodiments, similar to what is described above in conjunction with the method for picking goods 100, the unloading situation of the goods may include at least one of: (1) an expected return time of a buffer vehicle; (2) a numeric count of carriers waiting in line to unload goods; or (3) a category and quantity of goods waiting in line to be unloaded.

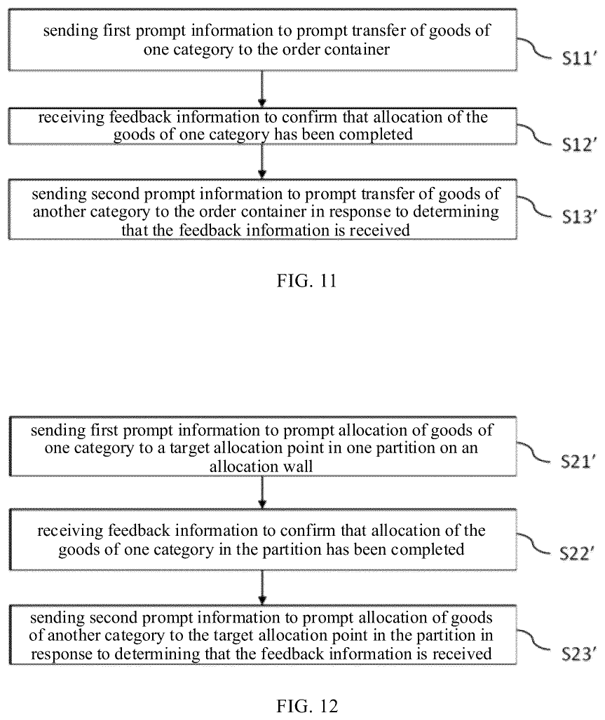

Various methods for prompting allocation in the process S250 according to embodiments of the present disclosure is described below with reference to FIGS. 11 to 14. It is to be understood that different methods described below are not mutually exclusive, and they may be executed at different times or for different allocation points in a same warehousing system, or may also be combined and executed at a same time and for a same allocation point.

FIG. 11 is a schematic diagram illustrating another method for processing a goods picking order provided in some embodiments of the present disclosure. The method shown in FIG. 11 includes steps as follows.

In S11′, first prompt information is sent to prompt transfer of goods of one category to the order container located at the target allocation point.

In S12′, feedback information is received to confirm that allocation of the goods of one category has been completed.

In S13′, second prompt information is sent to prompt transfer of goods of another category to the order container in response to determining that the feedback information is received.

In some examples, the first prompt information and the second prompt information sent by the warehouse management system C may be provided to, for example, an operator by the information input/output device D. Such a device D may be, for example, a display device or a voice device.

For example, according to the method shown in FIG. 11, a prompt may be given to allocate a plurality of categories of goods for one allocation point until all allocation tasks for a current order container at the allocation point are completed. The operator may perform allocation to a next allocation point after completing allocation to the one allocation point. Preferably, for the one allocation point, order picking of the current order container is completed after all the allocation tasks for the current order container are completed. The method for processing the goods picking order 200 may further include sending prompt information to prompt the replacement of the order container at the allocation point.

Illustratively, a sequence of categories of goods to be allocated prompted by sent prompt information corresponds to a sequence of compartment positions of these goods on the buffer vehicle. This allows the goods to be taken out and allocated in sequence according to positions of a plurality of compartments of the buffer vehicle during allocation, which may reduce an attention requirement of the operator, thus reducing an error rate in a process of picking and delivering goods and improving the picking efficiency.

FIG. 12 is a schematic diagram illustrating yet another method for processing a goods picking order provided in some embodiments of the present disclosure. The method shown in FIG. 12 includes steps as follows.

In S21′, first prompt information is sent to prompt allocation of goods of one category to a target allocation point in one partition on an allocation wall.

In S22′, feedback information is received to confirm that allocation of the goods of one category in the partition has been completed.

In S23′, second prompt information is sent to prompt allocation of goods of another category to the target allocation point in the partition in response to determining that the feedback information is received.

In some examples, the partition is an area formed by two or more adjacent allocation points on the allocation wall. The partition may be fixedly set or dynamically determined according to a category and/or quantity of goods required by the order container at the allocation point, for example. As an example only, such partitions a and b are schematically shown in FIG. 3 with dashed boxes.

For example, in the method shown in FIG. 12, a prompt is given to perform allocation in the partition according to a predetermined sequence of categories of goods. After the feedback information confirming that the allocation of the goods of one category in the partition is completed is received, a control instruction may be issued to immediately replace an order container that has been picked. A prompt continues to be given to perform allocation in the partition according to the predetermined sequence.

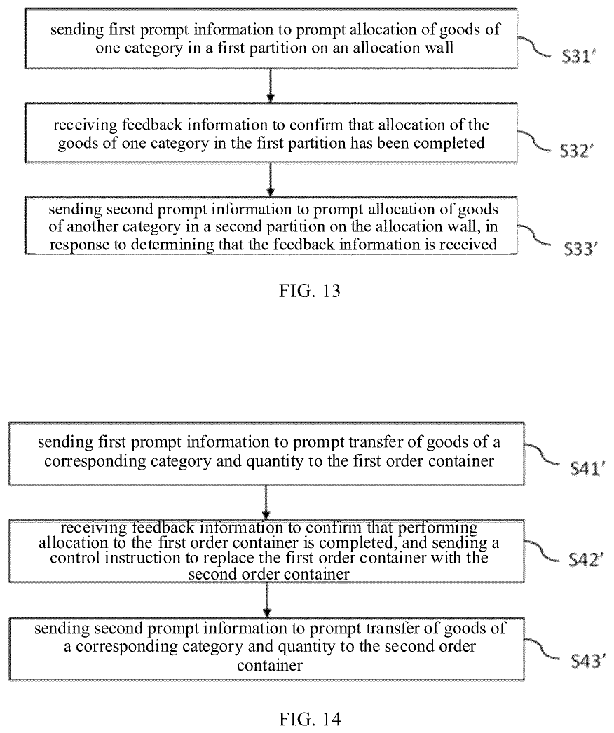

FIG. 13 is a schematic diagram illustrating yet another method for processing a goods picking order provided in some embodiments of the present disclosure. The method shown in FIG. 13 includes steps as follows.

In S31′, first prompt information is sent to prompt allocation of goods of one category to a target allocation point in a first partition on an allocation wall.

In S32′, feedback information is received to confirm that allocation of the goods of one category in the first partition has been completed.

In S33′, second prompt information is sent to prompt allocation of goods of another category to a target allocation point in a second partition on the allocation wall, in response to determining that the feedback information is received. The second partition includes two or more allocation points, and the second partition partially overlaps with the first partition.

In some examples, the two partitions a and b shown in FIG. 3 may be taken as examples of the first partition and the second partition applied in this method. The first partition and the second partition may be fixedly set, or may also be dynamically determined according to a category and/or quantity of goods required by the order container at the allocation point, for example.

FIG. 14 is a schematic diagram illustrating yet another method for processing a goods picking order provided in some embodiments of the present disclosure.

In some embodiments, in the method for processing the goods picking order according to the embodiment of the present disclosure, a first allocation task and a second allocation task may be generated for one target allocation point. The first allocation task is to transfer goods of a corresponding category and quantity to the first order container according to the first order associated with the first order container currently located at the target allocation point. The second allocation task is to transfer goods of a corresponding category and quantity to the second order container according to the second order associated with the second order container to be placed at the target allocation point after the first order is completed. In the process S230 of the method for processing the goods picking order according to the embodiment of the present disclosure, the first allocation task and the second allocation task may be determined as allocation tasks received by a same buffer vehicle.

In some embodiments, generating the first allocation task and the second allocation task for a same target allocation point includes at least one of: (1) generating a first allocation task to transfer goods of at least two categories in the buffer vehicle to the first order container according to the first order; (2) generating a second allocation task to transfer goods of at least two categories in the buffer vehicle to the second order container according to the second order; or (3) generating a first allocation task to transfer goods of a first category in the buffer vehicle to the first order container according to the first order, and generating a second allocation task to transfer goods of a second category different from the first category in the buffer vehicle to the second order container according to the second order.

A prompt is given by the above-mentioned three situations to perform allocation of a non-single category of goods in an operation process of using the buffer vehicle to take goods off the carrier and allocate them to the order container, which is conducive to greatly improving the picking efficiency.

In the case that the first allocation task and the second allocation task are generated for the same target allocation point and are determined as the allocation tasks received by the same buffer vehicle, the method shown in FIG. 14 may be used to perform joint allocating/picking of the first order and the second order. As shown in FIG. 14, the method may include steps as follows.

In S41′, first prompt information is sent to prompt transfer of goods of a corresponding category and quantity from the buffer vehicle to the first order container.

In S42′, feedback information is received to confirm that performing allocation to the first order container is completed, and a control instruction is sent to replace the first order container at the target allocation point with the second order container.

In S43′, second prompt information is sent to prompt transfer of goods of a corresponding category and quantity from the buffer vehicle to the second order container.

For example, the method shown in FIG. 14 is used to assist in joint allocating of a plurality of orders, which makes full use of characteristics that the buffer vehicle is able to carry a plurality of categories and a large number of goods, and is conducive to achieving efficient order picking.

In some embodiments, the method for processing the goods picking order according to the embodiment of the present disclosure may further include, when an error occurs in a category or a quantity of goods in the order container or on the buffer vehicle, sending error prompt information to indicate a relevant order container to which a same batch of goods is allocated by using a same buffer vehicle and/or to indicate a relevant shelf.

According to an embodiment of the present disclosure, a warehousing system is provided and includes an allocation station, a control device, a workstation, and a buffer device. The allocation station is arranged with a plurality of allocation points. Each allocation point is configured to place an order container. The control device is configured to generate an unloading task according to goods to be allocated corresponding to a plurality of orders to be processed, and generate an allocation task according to a category and quantity of target goods corresponding to an associated order, among the plurality of orders to be processed, associated with an order container at each target allocation point in the allocation station. The allocation task is configured to allocate the target goods on a buffer vehicle into the order container. The workstation is coupled to the control device and configured to unload goods to be allocated to the buffer device according to a category of the goods to be allocated, according to the unloading task. The buffer device includes the buffer vehicle. The buffer vehicle runs between the workstation and the allocation station, and the buffer vehicle is coupled to the control device and is configured to transport the goods to be allocated to the allocation station and pass through a plurality of target allocation points of the allocation station, to allow an allocation object to perform the allocation task.

In some embodiments, the control device is configured to determine a category and quantity of the goods to be allocated according to the plurality of orders to be processed. The workstation is configured to place the goods to be allocated to the buffer vehicle according to the category and quantity of the goods to be allocated. The goods to be allocated include the target goods.

In some embodiments, the workstation is configured to place at least two categories of the goods to be allocated to a same buffer vehicle according to the category and quantity of the goods to be allocated.

In some embodiments, the buffer vehicle is provided with a plurality of compartments, and the workstation is configured to place different categories of the goods to be allocated into different compartments of a same buffer vehicle according to the category and quantity of the goods to be allocated.

In some embodiments, the allocation task includes allocating at least two categories of the target goods on the buffer vehicle into an order container at one target allocation point, and/or transferring different categories of the target goods on the buffer vehicle to order containers at different target allocation points, respectively.

In some embodiments, the allocation object includes an allocation device. The control device is configured to generate a first allocation task and a second allocation task according to the category and quantity of the target goods corresponding to the order container at the target allocation point. The first allocation task is configured to instruct the allocation device to allocate target goods of a first category from the buffer vehicle to the order container at the target allocation point, and the second allocation task is configured to instruct the allocation device to allocate target goods of a second category from the buffer vehicle to the order container at the target allocation point. The allocation device is configured to perform the first allocation task and perform the second allocation task after the first allocation task is completed.

In some embodiments, the warehousing system includes an information input/output device. The allocation object includes an allocation person. The control device is configured to generate first allocation prompt information according to the category and quantity of the target goods corresponding to the order container at the target allocation point, in which the first allocation prompt information is configured to prompt the allocation person to allocate target goods of a first category from the buffer vehicle to the order container at the target allocation point, and generate second allocation prompt information in response to the allocation person completing allocation of the target goods of the first category, in which the second allocation prompt information is configured to prompt the allocation person to allocate target goods of a second category from the buffer vehicle to the order container at the target allocation point. The information input/output device is configured to output the first allocation prompt information and the second allocation prompt information.

In some embodiments, the allocation station includes an allocation wall, and a plurality of allocation points including the target allocation point are arranged on the allocation wall, and allocation walls exist and are arranged in parallel or in a U-shape. The control device is configured to determine a shortest path for the buffer vehicle to pass through the plurality of target allocation points according to an arrangement of the allocation walls. The buffer vehicle is configured to pass through the plurality of target allocation points along the shortest path.

In some embodiments, the allocation wall is divided into a plurality of partitions, and each partition includes at least two allocation points, and the allocation object includes an allocation device. The control device is configured to generate a third allocation task and a fourth allocation task according to a category and quantity of target goods corresponding to a target allocation point in a first partition. The third allocation task is configured to instruct the allocation device to allocate target goods of a third category from the buffer vehicle to an order container at the target allocation point in the first partition, the first partition is one of the plurality of partitions, the fourth allocation task is configured to instruct the allocation device to allocate target goods of a fourth category from the buffer vehicle to an order container at a target allocation point in the first partition or a second partition, and the second partition is a partition among the plurality of partitions that is different from the first partition. The allocation device is configured to perform the third allocation task and perform the fourth allocation task after the third allocation task is completed.

In some embodiments, the allocation wall is divided into a plurality of partitions, and each partition includes at least two allocation points, and the warehousing system includes an information input/output device, and the allocation object includes allocation person. The control device is configured to generate third allocation prompt information according to a category and quantity of target goods corresponding to a target allocation point in a first partition. The third allocation prompt information is configured to prompt the allocation person to allocate target goods of a third category from the buffer vehicle to an order container at the target allocation point in the first partition, and the first partition is one of the plurality of partitions, and generate fourth allocation prompt information, in response to the allocation person completing allocation of the target goods of the third category. The fourth allocation prompt information is configured to prompt the allocation person to allocate target goods of a fourth category from the buffer vehicle to an order container at a target allocation point in the first partition or a second partition. The second partition is a partition among the plurality of partitions that is different from the first partition. The information input/output device is configured to output the third allocation prompt information and the fourth allocation prompt information.

In some embodiments, the control device is configured to determine an allocation sequence corresponding to the category of the target goods according to the target goods, and generate the allocation task according to the allocation sequence corresponding to the category of the target goods. The allocation task is configured to instruct the allocation object to allocate target goods into an order container at a target allocation point in a partition in the allocation sequence, replace an order container that has completed allocation after the order container has completed allocation, and continue to perform allocation in a partition in line with the allocation sequence.

In some embodiments, the associated order of the target allocation point includes a first order and a second order. The first order is associated with a first order container currently located at the target allocation point, and the second order is associated with a second order container to be placed at the target allocation point after the first order is completed. The workstation is configured to place target goods corresponding to the first order and the second order to the buffer vehicle, to allow the allocation object to allocate target goods of a category and quantity corresponding to the first order from the buffer vehicle to the first order container, and transfer target goods of a category and quantity corresponding to the second order from the buffer vehicle to the second order container, in response to the first order container completing allocation and the first order container being replaced with the second order container.

In some embodiments, the first order and the second order satisfy at least one of: the first order corresponding to at least two categories of target goods; the second order corresponding to at least two categories of target goods; or the first order and the second order corresponding to different categories of target goods, respectively.

In some embodiments, the warehousing system further includes a mobile device. The control device is configured to generate a handling task according to the goods to be allocated corresponding to the plurality of orders to be processed. The mobile device is configured to transport a carrier on which the goods to be allocated are located to the workstation according to the handling task. The workstation is configured to unload the goods to be allocated on the carrier to the buffer device. The buffer device includes the buffer vehicle.

In some embodiments, the control device is configured to generate the handling task according to an unloading situation of goods at the workstation. The unloading situation of the goods at the workstation includes at least one of: an expected return time of a buffer vehicle, a numeric count of carriers waiting in line to unload goods, or a category and quantity of goods waiting in line to be unloaded.

In some embodiments, the buffer device includes a plurality of buffer vehicles and/or buffer racks.

In some embodiments, the control device is further configured to check an order container to which a same batch of goods is allocated by using a same buffer vehicle and/or the carrier on which the goods to be allocated are located, when an error occurs in the category and quantity of the goods to be allocated in the order container at the target allocation point or on the buffer vehicle.

According to other embodiments of the present disclosure, the warehouse management system may include a memory and at least one processor. The memory is stored with computer-executable instructions that, when executed by the at least one processor, cause the at least one processor to perform the method for picking goods as described above.

According to other embodiments of the present disclosure, a non-transitory computer-readable storage medium having stored therein computer-executable instructions that, when executed by a processor, cause the processor to implement the method for picking goods and the method for processing the goods picking order as described above.

According to other embodiments of the present disclosure, a computer program product may include a computer program that, when executed by a processor, causes the processor to implement the method for picking goods and the method for processing the goods picking order as described above.

Meanwhile, the above description is only a preferred embodiment of the present disclosure and an explanation of the technical principles used. Those skilled in the art should understand that the scope of the present disclosure involved in the present disclosure is not limited to a technical solution formed by a specific combination of the above technical features, but also covers other technical solutions formed by any combination of the above technical features or their equivalent features without departing from the inventive concept. For example, the above features and technical features with similar functions disclosed in, but not limited to the present application are replaced with each other to form a technical solution.

1. A method for picking goods, comprising:
controlling a workstation to place the goods to be allocated corresponding to a plurality of orders to be processed on a buffer vehicle according to a category of goods to be allocated;
controlling the buffer vehicle to move and pass through a plurality of target allocation points of an allocation station; and
controlling, according to a category and quantity of target goods corresponding to an associated order, among the plurality of orders to be processed, associated with an order container at each target allocation point, an allocation object to allocate the target goods on the buffer vehicle into the order container, when the buffer vehicle passes through each target allocation point.

2. The method for picking goods of claim 1, wherein controlling the workstation to place the goods corresponding to the plurality of orders to be processed to the buffer vehicle according to the category of the goods to be allocated comprises:
determining a category and quantity of the goods to be allocated according to the plurality of orders to be processed; and
controlling, according to the category and quantity of the goods to be allocated, the workstation to place the goods to be allocated to the buffer vehicle; wherein the goods to be allocated comprise the target goods.

3. The method for picking goods of claim 2, wherein controlling, according to the category and quantity of the goods to be allocated, the workstation to place the goods to be allocated to the buffer vehicle comprises:
controlling, according to the category and quantity of the goods to be allocated, the workstation to place at least two categories of the goods to be allocated to a same buffer vehicle.

4. The method for picking goods of claim 2, wherein the buffer vehicle is provided with a plurality of compartments; and controlling, according to the category and quantity of the goods to be allocated, the workstation to place the goods to be allocated to the buffer vehicle comprises:
controlling, according to the category and quantity of the goods to be allocated, the workstation to place different categories of the goods to be allocated into different compartments of a same buffer vehicle.

5. The method for picking goods of claim 1, wherein controlling the allocation object to allocate the target goods on the buffer vehicle into the order container comprises at least one of:
controlling the allocation object to allocate at least two categories of the target goods on the buffer vehicle into an order container at one target allocation point; or
controlling the allocation object to transfer different categories of the target goods on the buffer vehicle to order containers at different target allocation points, respectively.

6. The method for picking goods of claim 5, wherein the allocation object comprises an allocation device; and controlling the allocation object to allocate the at least two categories of the target goods on the buffer vehicle into the order container at the one target allocation point comprises:
generating a first allocation task and a second allocation task according to the category and quantity of the target goods corresponding to the order container at the target allocation point; wherein the first allocation task is configured to instruct the allocation device to allocate target goods of a first category from the buffer vehicle to the order container at the target allocation point; and the second allocation task is configured to instruct the allocation device to allocate target goods of a second category from the buffer vehicle to the order container at the target allocation point; and
controlling the allocation device to perform the first allocation task, and controlling the allocation device to perform the second allocation task in response to the allocation device completing the first allocation task.

7. The method for picking goods of claim 5, wherein the allocation object comprises an allocation person; and controlling the allocation object to allocate the at least two categories of the target goods on the buffer vehicle into the order container at the one target allocation point comprises:
generating first allocation prompt information according to the category and quantity of the target goods corresponding to the order container at the target allocation point; wherein the first allocation prompt information is configured to prompt the allocation person to allocate target goods of a first category from the buffer vehicle to the order container at the target allocation point; and
generating second allocation prompt information in response to the allocation person completing allocation of the target goods of the first category; wherein the second allocation prompt information is configured to prompt the allocation person to allocate target goods of a second category from the buffer vehicle to the order container at the target allocation point.

8. The method for picking goods of claim 1, wherein the allocation station comprises an allocation wall, and a plurality of allocation points comprising the target allocation point are arranged on the allocation wall; and allocation walls exist and are arranged in parallel or in a U-shape;
wherein controlling the buffer vehicle to move and pass through the plurality of target allocation points of the allocation station comprises:
controlling the buffer vehicle to move and pass through the plurality of target allocation points of the allocation wall along a shortest path.

9. The method for picking goods of claim 8, wherein the allocation wall is divided into a plurality of partitions, and each partition comprises at least two allocation points; and the allocation object comprises an allocation device;
wherein controlling the allocation object to allocate the target goods on the buffer vehicle into the order container comprises:
generating a third allocation task and a fourth allocation task according to a category and quantity of target goods corresponding to a target allocation point in a first partition; wherein the third allocation task is configured to instruct the allocation device to allocate target goods of a third category from the buffer vehicle to an order container at the target allocation point in the first partition; the first partition is one of the plurality of partitions; the fourth allocation task is configured to instruct the allocation device to allocate target goods of a fourth category from the buffer vehicle to an order container at a target allocation point in the first partition or a second partition; and the second partition is a partition among the plurality of partitions that is different from the first partition; and
controlling the allocation device to perform the third allocation task, and controlling the allocation device to perform the fourth allocation task in response to the allocation device completing the third allocation task.

10. The method for picking goods of claim 8, wherein the allocation wall is divided into a plurality of partitions, and each partition comprises at least two allocation points; and the allocation object comprises an allocation person;
wherein controlling the allocation object to allocate the target goods on the buffer vehicle into the order container comprises:
generating third allocation prompt information according to a category and quantity of target goods corresponding to a target allocation point in a first partition; wherein the third allocation prompt information is configured to prompt the allocation person to allocate target goods of a third category from the buffer vehicle to an order container at the target allocation point in the first partition; and the first partition is one of the plurality of partitions; and
generating fourth allocation prompt information, in response to the allocation person completing allocation of the target goods of the third category; wherein the fourth allocation prompt information is configured to prompt the allocation person to allocate target goods of a fourth category from the buffer vehicle to an order container at a target allocation point in the first partition or a second partition; wherein the second partition is a partition among the plurality of partitions that is different from the first partition.

11. The method for picking goods of claim 10, wherein controlling the allocation object to allocate the target goods on the buffer vehicle into the order container comprises:
controlling, according to an allocation sequence corresponding to the category of the target goods, the allocation object to allocate target goods into an order container at a target allocation point in a partition, replacing an order container that has completed allocation after the order container has completed the allocation, and continuing to perform allocation in a partition in line with the allocation sequence.

12. The method for picking goods of claim 1, wherein the associated order of the target allocation point comprises a first order and a second order; and the first order is associated with a first order container currently located at the target allocation point, and the second order is associated with a second order container to be placed at the target allocation point after the first order is completed;
wherein controlling the workstation to place the goods to be allocated corresponding to the plurality of orders to be processed to the buffer vehicle according to the category of the goods to be allocated comprises:
controlling the workstation to place target goods corresponding to the first order and the second order to the buffer vehicle;
wherein controlling the allocation object to allocate the target goods on the buffer vehicle into the order container comprises:
controlling the allocation object to allocate target goods of a category and quantity corresponding to the first order from the buffer vehicle to the first order container; and
controlling the allocation object to transfer target goods of a category and quantity corresponding to the second order from the buffer vehicle to the second order container, in response to the first order container completing allocation and the first order container being replaced with the second order container.

13. The method for picking goods of claim 12, wherein the first order and the second order satisfy at least one of:
the first order corresponding to at least two categories of target goods;
the second order corresponding to at least two categories of target goods; or
the first order and the second order corresponding to different categories of target goods, respectively.

14. The method for picking goods of claim 1, wherein before controlling the workstation to place the goods to be allocated corresponding to the plurality of orders to be processed to the buffer vehicle according to the category of the goods to be allocated, the method further comprises:
controlling a mobile device to transport a carrier on which the goods to be allocated are located to the workstation;
wherein controlling the workstation to place the goods to be allocated corresponding to the plurality of orders to be processed to the buffer vehicle according to the category of the goods to be allocated comprises:
controlling the workstation to unload the goods to be allocated on the carrier to a buffer device; wherein the buffer device comprises the buffer vehicle.

15. The method for picking goods of claim 14, wherein controlling the mobile device to transport the carrier on which the goods to be allocated are located to the workstation comprises:
controlling the mobile device to transport the carrier on which the goods to be allocated are located to the workstation according to an unloading situation of goods at the workstation;
wherein the unloading situation of the goods at the workstation comprises at least one of: an expected return time of the buffer vehicle, a numeric count of carriers waiting in line to unload goods, or a category and quantity of goods waiting in line to be unloaded.

16. The method for picking goods of claim 14, wherein the buffer device comprises at least one of: a plurality of buffer vehicles or buffer racks.

17. The method for picking goods of claim 1, further comprising:
checking at least one of: an order container to which a same batch of goods is allocated by using a same buffer vehicle or a carrier on which the goods to be allocated are located, when an error occurs in the category and quantity of the goods to be allocated in the order container at the target allocation point or on the buffer vehicle.

18. A warehousing system, comprising:
an allocation station arranged with a plurality of allocation points, wherein each allocation point is configured to place an order container;
a control device configured to generate an unloading task according to goods to be allocated corresponding to a plurality of orders to be processed; and generate an allocation task according to a category and quantity of target goods corresponding to an associated order, among the plurality of orders to be processed, associated with an order container at each target allocation point in the allocation station; wherein the allocation task is configured to allocate the target goods on a buffer vehicle into the order container;
a workstation coupled to the control device and configured to unload goods to be allocated to the buffer vehicle according to a category of the goods to be allocated, according to the unloading task; and
a buffer device comprising the buffer vehicle, wherein the buffer vehicle runs between the workstation and the allocation station, and the buffer vehicle is coupled to the control device and is configured to transport the goods to be allocated to the allocation station and pass through a plurality of target allocation points of the allocation station, to allow an allocation object to perform the allocation task.

19.-34. (canceled)

35. A control device, comprising:
a memory, and
at least one processor;
wherein the memory is stored with computer-executable instructions that, when executed by the at least one processor, cause the at least one processor to:
control a workstation to place goods to be allocated corresponding to a plurality of orders to be processed on a buffer vehicle according to a category of goods to be allocated;
control the buffer vehicle to move and pass through a plurality of target allocation points of an allocation station; and
control, according to a category and quantity of target goods corresponding to an associated order, among the plurality of orders to be processed, associated with an order container at each target allocation point, an allocation object to allocate the target goods on the buffer vehicle into the order container, when the buffer vehicle passes through each target allocation point.

36. A non-transitory computer-readable storage medium having stored therein computer-executable instructions that, when executed by a processor, cause the processor to implement the method for picking goods of claim 1.

37. (canceled)
